(19) United States
(12) Patent Application Publication
(10) Pub. No.: US 2008/0082453 A1
(43) Pub. Date: Apr. 3, 2008

(54) Methods for bundling credits with electronic devices and systems for implementing the same

(75) Inventors: Jeffrey Brunet, Richmond Hill (CA); Ian Collins, Markham (CA); Yousuf Chowdhary, Maple (CA); Eric Li, Scarborough (CA)

Correspondence Address: CARR & FERRELL LLP, 2200 GENG ROAD, PALO ALTO, CA, 94303, US

(73) Assignee: Storage Appliance Corporation

(21) Appl. No.: 11/906,646

(22) Filed: Oct. 2, 2007

Related U.S. Application Data
(60) Provisional application No. 60/848,800, filed on Oct. 2, 2006.

(51) Int. Cl. G06F 17/30; G06Q 30/00; H04K 1/00

(52) U.S. Cl. 705/76; 705/14; 705/7

(57) ABSTRACT

Methods are provided in which electronic devices are distributed while systems are maintained for conducting transactions with the electronic devices across a network. Each electronic device includes a unique device identification, and across the network a database stores an amount of credit in association with each unique device identification. To conduct a transaction, the electronic device establishes a connection over the network to a network location that can access the database. The network location receives the device identification from the electronic device and uses the device identification to determine the amount of stored credit from the database. A user of the electronic device can then exchange stored credit for goods and/or services, transfer credits to others, and purchase additional credits.

### CROSS-REFERENCE TO RELATED APPLICATIONS

This application claims the benefit of U.S. Provisional Patent Application No. 60/848,800 on Oct. 2, 2006 and entitled “A Method and a System for Bundling Credits with a Backup Appliance for External Services and the Redemption of the Same,” incorporated herein by reference.

### BACKGROUND OF THE INVENTION

1. Field of the Invention

The present invention relates generally to the field of consumer electronic devices and more particularly to methods for bundling stored credits in association with consumer electronic devices.

2. Description of the Prior Art

Presently, when electronic devices are sold, the devices can be bundled with rebates or promotions for related goods or services. Such rebates and promotions typically take the form of a coupon or postcard that has to be completed and mailed. Many consumers either lose or discard the forms, or do not take the time to complete the process to obtain the rebate or promotion. Those that do take the time generally have to wait on the order of weeks or months to receive their rebate or access to the promotion. In still other instances, any mistakes made in completing the process can lead to further delays and frustration.

### SUMMARY

An exemplary business method of the invention comprises maintaining a database, maintaining a network location, and distributing an electronic device such as a consumer appliance. The database associates a unique device identification for the electronic device with an amount of credit stored in the database for the electronic device. The electronic device is configured to, upon being coupled to the Internet, establish a connection to the network location and to send the unique device identification to the network location. The network location has access to the database, is configured to read the amount of stored credit from the database in response to receiving the unique device identification, and is further configured to communicate to the electronic device the amount of credit stored in the database.

In various embodiments, the unique device identification is derived from a serial number of the electronic device or from a random ID generator. In other embodiments, the electronic device comprises a number of sub-components and the unique device identification is derived from a combination of the serial numbers of at least some of the sub-components. The electronic device may store the unique device identification as an encrypted file. The electronic device can include a Graphical User Interface (GUI), a display, and/or a biometric device in different embodiments. The electronic device can be configured to connect to the Internet through another electronic device, such as a kiosk, in some instances. Additionally, the electronic device can be configured to establish the connection to the network location in response to a trigger. The electronic device can be further configured to, upon being coupled to the Internet, automatically establish the connection to the network location and automatically send the unique device identification to the network location.

In some embodiments, distributing the electronic device comprises selling the electronic device. Maintaining the database can include maintaining a plurality of user accounts in association with the unique device identification. Maintaining the database can also include maintaining a plurality of stored credits in association with the unique device identification.

Further, the business method of the invention can comprise additional steps such as associating the unique device identification with the electronic device at a time of manufacture of the electronic device. The method can further comprise determining the amount of credit to associate with the unique device identification after the unique device identification has been associated with the electronic device. The amount of stored credit can be assigned to the unique device identification according to a criterion, in some situations. The method may further comprise downloading an advertisement to the electronic device. An alias can be stored in the database in association with the unique device identification, in some embodiments. The method can also comprise the network location recording a transaction associated with the unique device identification and assigning a transaction ID to the transaction. The method can also comprise adding additional credit to the amount of credit stored in the database. Moreover, the method can comprise employing a portion of the amount of stored credit in a transaction, such as to purchase goods and/or services or to transfer the portion of the amount of stored credit to another unique device identification.

### BRIEF DESCRIPTION OF DRAWINGS

FIG. 1 is a schematic representation of electronic devices coupled across a network to network location and a database, according to exemplary embodiments of the invention.

FIG. 2 shows a table stored by the database of FIG. 1, according to an exemplary embodiment of the invention.

FIG. 3 is a flow-chart representation of a business method according to an exemplary embodiment of the invention.

FIG. 4 illustrates steps for conducting a transaction between an electronic device and the network location of FIG. 1, according to an exemplary embodiment of the invention.

FIG. 5 is a flow-chart representation of a method for associating an alias with a unique device identification according to an exemplary embodiment of the invention.

FIG. 6 is a flow-chart representation of a method for purchasing extra credit according to an exemplary embodiment of the invention.

### DETAILED DESCRIPTION OF THE INVENTION

The present invention is directed to business methods for bundling credits with electronic devices so that a user of an electronic device can apply the bundled credits to the purchase of certain goods or services. According to various embodiments of the invention, the electronic device includes a unique device identification, and a database stores an amount of credit in association with the unique device identification. In order for a user of the electronic device to access the stored credit, the electronic device establishes a connection to a network location that has access to the database. The network location can support a variety of transactions that employ the stored credit, once the electronic device and the network location are connected. Examples of such transactions include the exchange of stored credits for goods and/or services, the transfer of credits, and the purchase of additional credits.

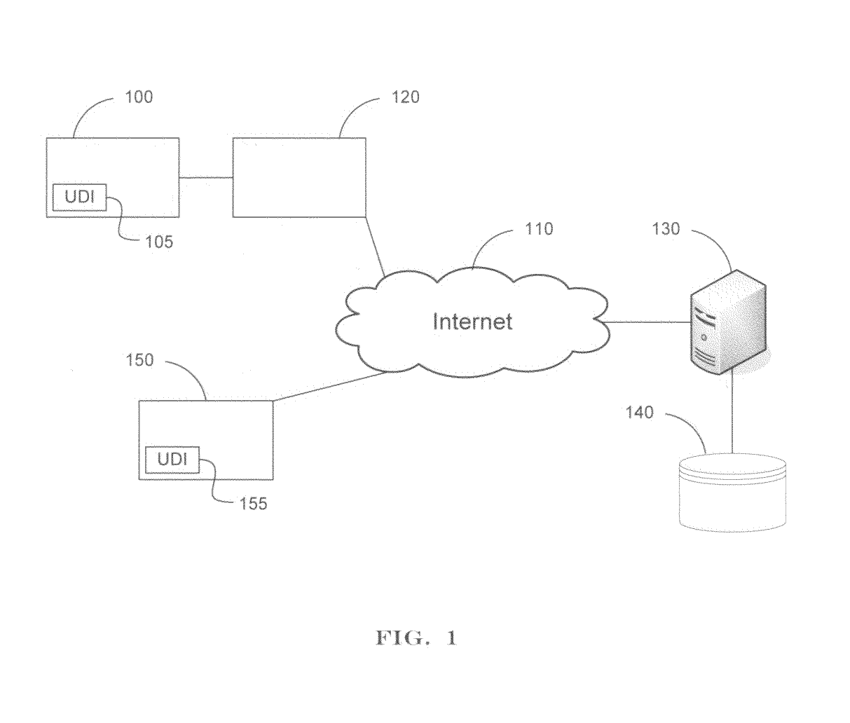

FIG. 1 illustrates systems for implementing the methods of the invention. In FIG. 1, an electronic device 100 includes a unique device identification (UDI) 105 and is coupled to the Internet 110, or to any other suitable network such as a proprietary or private network, a Wide Area Network (WAN), or a Local Area Network (LAN), through another electronic device 120. Also, a network location 130 is coupled to both the Internet 110 and a database 140. It should be noted that although FIG. 1 shows the database 140 directly connected to the network location 130, in some embodiments the database 140 is instead coupled to the network location 130 through the Internet 110. In some embodiments, an electronic device 150 including a unique device identification 155 can be coupled to the Internet 110, or another suitable network as described above, without going through another electronic device 120.

The electronic devices 100, 150 can comprise consumer appliances, for example, computers and computing devices, memory devices such as USB memory keys, media players such as VCRs, DVD players, and MP3 players, and sporting equipment such as treadmills. One particular example of a consumer appliance is a backup system such as described is U.S. application Ser. No. 11/801,240 filed on May 8, 2007 and entitled “Automatic Connection to an Online Service Provider from a Backup System,” which is incorporated herein by reference.

Optional further features of the electronic devices 100, 150 include a display, such as an LCD display, a GUI, and a biometric device. Various functionalities of the GUI will be described in greater detail, below. The biometric device can be used to authenticate the user and can comprise, for example, a finger-print scanner or an iris scammer. The electronic devices 100, 150 can also incorporate a security layer in the form of a password or a Personal Identification Number (PIN).

As noted, the electronic device 100 can be coupled to the Internet 110 through the electronic device 120. Examples of the electronic device 120 include desktop and laptop computers, Personal Digital Assistants (PDAs), smartphones, televisions, settop boxes, personal video recorders (PVRs), kiosks, and so forth. The electronic device 120 can be configured to connect to the Internet 110 in any number of ways including through a modem or through a Local Area Network (LAN) either with a wired or a wireless connection. The electronic device 120 can further include, for example, a USB port to allow the electronic devices 100, 120 to be connected by a USB connector or cable.

By contrast, the electronic device 150 can be coupled to the Internet 110 without going through the electronic device 120. Accordingly, electronic device 150 is itself configured to connect to the Internet 110 in any number of ways including through a modem or through a Local Area Network (LAN) either with a wired or a wireless connection. In some embodiments, the electronic device 150 comprises an integrated port for connecting to the Internet 110.

The unique device identifications 105, 155 can comprise numbers and/or character strings that are unique to the electronic devices 100, 150, and in some instances are associated with the electronic devices 100, 150 at the time the electronic devices 100, 150 are manufactured. The electronic devices 100, 150 can store the unique device identifications 105, 155 as encrypted files in some embodiments to safeguard the unique device identifications 105, 155. Exemplary encryption methods include Public Key Infrastructure (PKI) and tokens. In further embodiments, the electronic devices 100, 150 store the unique device identifications 105, 155 in hidden folders so that users of the electronic devices 100, 150 cannot access and/or alter the unique device identifications 105, 155.

The unique device identifications 105, 155 can be the serial numbers of the electronic devices 100, 150, or can be derived from those serial numbers. The unique device identifications 105, 155 can also be derived from a random number generator. In some embodiments, the electronic devices 100, 150 comprise a number of sub-components and the unique device identifications 105, 155 are derived from a combination of the serial numbers of at least some of the sub-components.

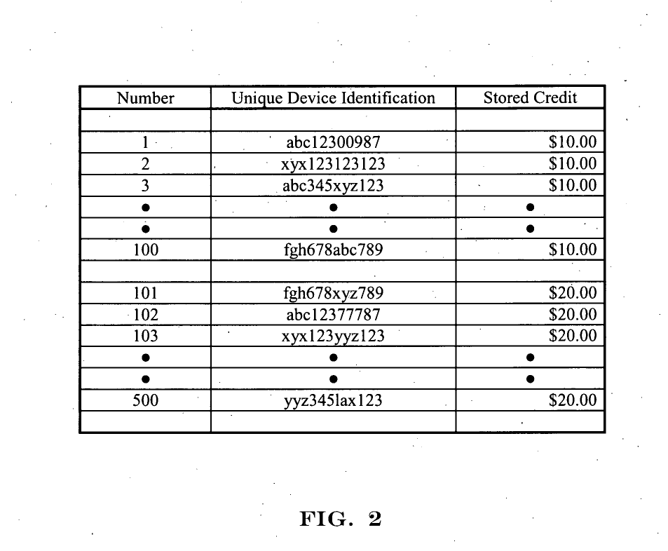

As provided above, the database 140 associates the unique device identifications 105, 155 for the electronic devices 100, 150 with amounts of credit stored in the database for the electronic devices 100, 150. FIG. 2 shows an exemplary table stored by the database 140 for associating unique device identifications 105, 155 with amounts of credit. It will be appreciated that different amounts of credit can be associated with different unique device identifications 105, 155. In the example of FIG. 2, $10.00 of credit is stored for each of the first 100 entries and $20.00 for each of entries 101 through 500.

In some embodiments, the amount of credit assigned to each unique device identification 105, 155 can be determined according to a criterion. As an example, the criterion can be based on the geographic regions in which the electronic devices 100, 150 are intended to be distributed. For instance, the electronic devices 100, 150 associated with the first 100 unique device identifications 105, 155 can be intended to be distributed in one geographic region (e.g., Nevada) and are associated with one amount of credit, while the remaining electronic devices 100, 150 can be intended to be distributed in another geographic region (e.g., California) and are therefore associated with another amount of credit. Another example of a criterion is the identity of the retailer that will be distributing the electronic devices 100, 150. Associating credit with the electronic devices 100, 150 in the database 140, rather than storing the credit within the electronic devices 100, 150, permits the amount of credit to be determined after the electronic devices 100, 150 have been manufactured and also allows the amount of credit to be modified without having to access the actual electronic devices 100, 150.

The network location 130 can be, for example, a computing server having a Uniform Resource Locator (URL) so that electronic devices can establish connections to the network location 130. The network location 130 can support a variety of transactions with the electronic devices 100, 150. Exemplary transactions include exchanging stored credits, or another form of payment, for goods and/or services, transferring credits, and purchasing additional credits. The network location 130 can also facilitate a variety of other activities such as allowing user settings (e.g. user name and password) to be modified.

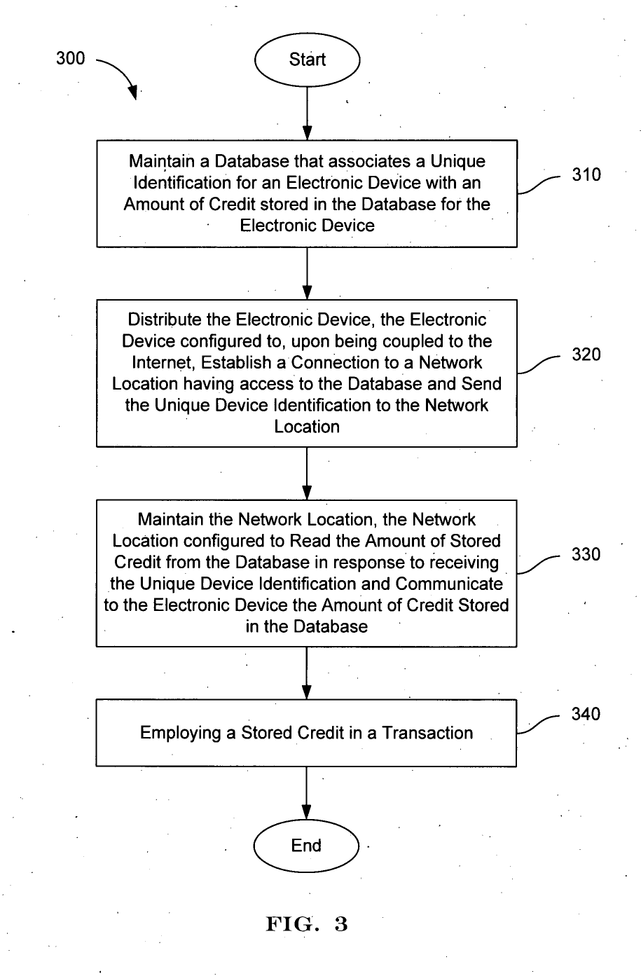

FIG. 3 illustrates an exemplary business method 300 of the present invention. The business method 300 comprises a Step 310 of maintaining a database, a Step 320 of distributing an electronic device, and a Step 330 of maintaining a network location. According to the business method 300, the database that is maintained in Step 310 associates a unique device identification for the electronic device with an amount of credit stored in the database for the electronic device. Additionally, the electronic device distributed in Step 320 is configured to, upon being coupled to the Internet, establish a connection to the network location and send the unique device identification to the network location. The network location maintained in Step 330 has access to the database and is configured to read the amount of stored credit from the database in response to receiving the unique device identification and communicate to the electronic device the amount of credit stored in the database for that unique device identification. The business method 300 can further comprise, in some embodiments, a Step 340 of employing a stored credit in a transaction.

Steps 310 and 330 comprise, respectively, maintaining the database and the network location so that an electronic device distributed in Step 320 can, at any time, establish a connection to the network location and carry out a transaction employing a stored credit. In Step 310, maintaining the database can include, for example, updating a table (e.g., FIG. 2) in which unique device identifications are associated with stored credits and potentially other information. Other information can include user account information, such as a user's name, an alias, password, e-mail address, and so forth.

In some embodiments, more than one user account can be associated with a unique device identification where more than one person may use the electronic device, such as a personal computer that is shared by members of a family. Here, each family member can have a separate user account associated with the unique device identifier. Thus, maintaining the database in Step 310 can further include maintaining a plurality of user accounts in association with the unique device identifier.

In further embodiments, the electronic device is bundled with stored credits from more than one vendor. Each vendor can have a separate unique device identification stored within the electronic device, and each separate unique device identification can be associated with one of a plurality of stored credits within the database. Alternatively, each of the plurality of stored credits can be associated with the same unique device identification but in some other way identified with a particular vendor. Therefore, maintaining the database in Step 310 can also include maintaining a plurality of stored credits in association with the unique device identification, or in association with a plurality of separate unique device identifications.

The electronic device is distributed in Step 320 in order to provide the electronic device to a user and can be bundled with stored credits in order to entice the user to try goods and/or services from a particular vendor. Distributing the electronic device can include selling the electronic device as well as providing the device for free, for example, as part of a marketing campaign. Once the electronic device has been distributed in Step 320, in some embodiments, the business method 300 can further comprise the Step 340 of employing a stored credit in a transaction. Still other optional steps of the method 300 are described below.

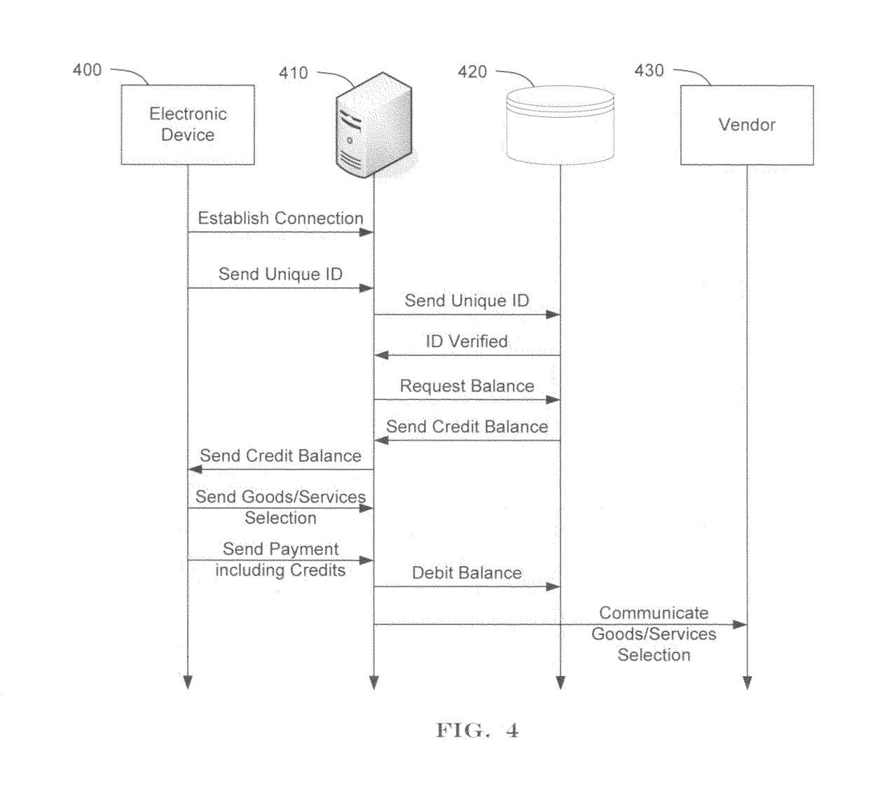

The Step 340 of employing the stored credit in a transaction can comprise a number of steps, and FIG. 4 illustrates an exemplary series of such steps. Following a general overview of the steps illustrated in FIG. 4, some of those steps will be discussed in greater detail. In FIG. 4 an electronic device 400 having a unique device identifier establishes a connection to a network location 410. The unique device identifier is sent by the electronic device 400 and received by the network location 410. Next, the unique device identifier is sent by the network location 410 to a database 420 for verification. The database 420 then sends confirmation of verification of the unique device identifier back to the network location 410. The network location 410 requests a stored credit balance from the database 420, and the database 420 sends the stored credit balance back to the network location 410. The network location 410 then sends the stored credit balance to the electronic device 400 which can display the stored credit balance to a user.

Next, the network location 410 receives from the electronic device 400 a user selection of goods and/or services offered by a vendor 430. The network location 410 then receives payment instructions from the electronic device 400 for the goods and/or services. The payment instructions tell the network location 410 how to collect the funds for the selection of goods and/or services, for instance, by charging the expense to a credit card account, debiting the expense from a checking or savings account, deducting stored credit, or a combination of these. Where the payment instructions include the use of stored credits, the network location 410 appropriately debits the amount of credit stored by the database 420 for the unique device identification. The network location 410 also communicates the goods and/or services selection to the vendor 430 so that vendor 430 can provide the goods and/or services to the user.

The exemplary steps in FIG. 4 begin with the electronic device 400 establishing a connection to the network location 410. As illustrated in FIG. 1, an electronic device 400 can either connect to the network location 410 directly over the Internet, or indirectly through another electronic device 120 (FIG. 1) to reach the Internet. Where the electronic device 400 connects through another electronic device 120, and the other electronic device 120 is actively connected to the Internet, the electronic device 400 can automatically connect to the network location 410, in some instances. Where the electronic device 400 connects through another electronic device 120, and the other electronic device 120 is not actively connected to the Internet, in some embodiments the electronic device 400 is configured to automatically initiate a connection to the Internet. Whether or not the electronic device 400 connects to the Internet through another electronic device 120, in some embodiments the electronic device 400 automatically establishes the connection to the network location 410 upon being coupled to the Internet. The electronic device 400 may also be configured to display a warning to the user, or otherwise alert the user, where an Internet connection cannot be established or the network location 410 is not available.

In some embodiments, the electronic device 400 establishes a connection to the network location 410 in response to a trigger. Examples of triggers include a user request or the occurrence of some event. Exemplary events that can trigger the electronic device 400 to establish a connection to the network location 410 include the expiration of a set period of time or the accumulation of data beyond a threshold. For instance, where the electronic device 400 is a backup system that accumulates photos for printing, once the number of photos exceeds a threshold the electronic device 400 is triggered to establish a connection to the network location 410.

Once the electronic device 400 has established a connection to the network location 410, the electronic device 400 can send the unique device identification and the network location 410 can receive the unique device identification. In some instances the electronic device 400 can automatically send the unique device identification in response to the electronic device 400 establishing the connection to the network location 410.

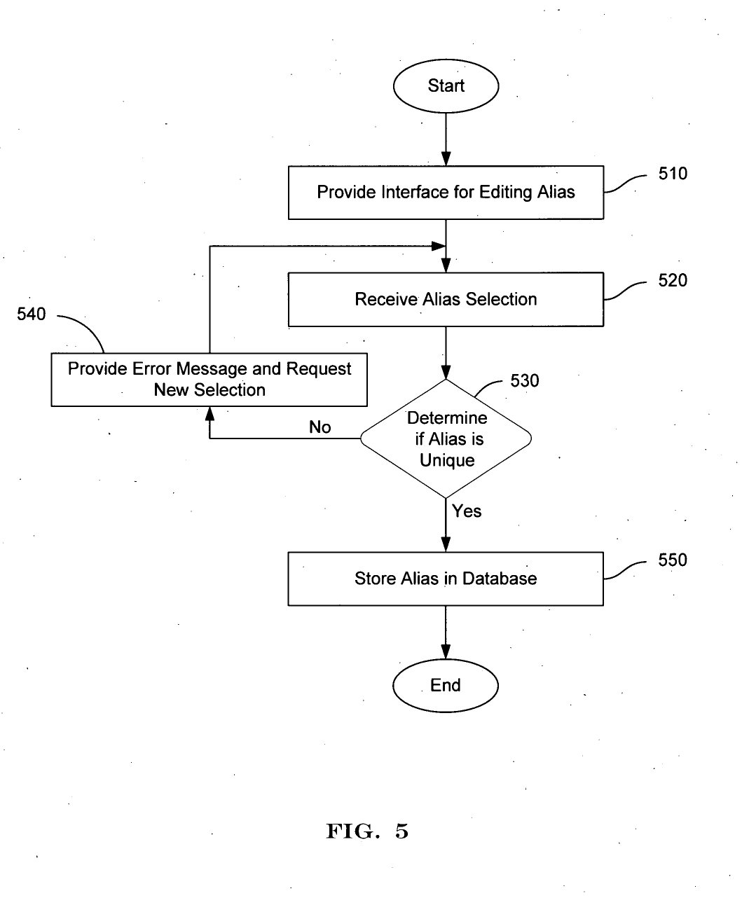

After the unique device identification has been verified and the stored credit balance has been sent to the electronic device 400, the electronic device 400 can display the stored credit balance to a user. In some embodiments the electronic device 400 displays the stored credit balance on a display of the electronic device 400, while in other embodiments the electronic device 400 displays the stored credit balance on a display of another electronic device 120 (FIG. 1). In further embodiments, the display is used to display advertisements that have been downloaded by the electronic device 400 from the network location 410.

Where the electronic device 400 includes a GUI, the GUI can be used to select goods and/or services. Alternately, a GUI of another electronic device 120 (FIG. 1) can be used to select goods and/or services. Although not shown in FIG. 4, other actions can also be undertaken through the GUI of the electronic device 400 or of the other electronic device 120. For example, a GUI can be used to communicate with the network location 410 to modify user settings such as user name and password, billing address, and commonly used credit card numbers. A GUI can also be used to change settings of the electronic device 400, such as a value of a threshold for triggering a connection to the network location 410. A GUI can also be used to establish an alias as described below with respect to FIG. 5.

In the illustrated example of FIG. 4, a transaction that employs a stored credit comprises selecting a payment to pay for selected goods and/or services, where the payment type includes the use of stored credits, and debiting the stored credit balance in the database 420. In some cases the payment can be limited to the use of stored credits, where the stored credit balance exceeds the cost of the goods and/or services. In other situations the payment can be split between the use of stored credits and another type of payment, such as with a credit card account. In the event that a transaction cannot be completed, the electronic device 400 can signal a warning to the user, in some embodiments. Other examples of transactions that employ stored credits are described below.

The network location 410, in some embodiments, is configured to record transactions associated with the unique device identification. In some instances, the network location 410 assigns a unique transaction ID to each transaction. Records of the transactions can be stored in the database 420 is association with the unique device identification. In a similar fashion, the network location 410 can record in the database 420 other information not pertaining to the electronic device 400 nor to any particular transaction. Such information being, for example, the number of times the electronic device 400 has established a connection to the network location 410 and the last time electronic device 400 established a connection to the network location 410.

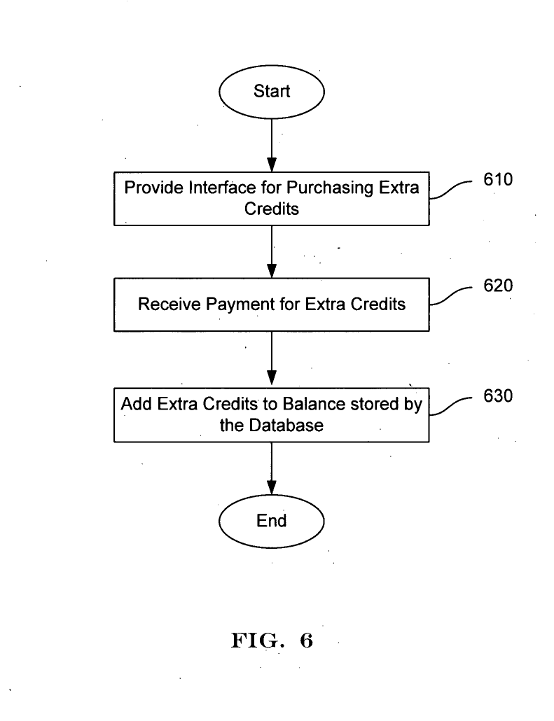

The business method 300 (FIG. 3) can optionally include additional steps, some of which have already been described above, while others are described below with respect to FIGS. 5 and 6. It was noted above, for instance, that advertisements can be downloaded to the electronic device 400 from the network location 410. Thus, the method 300 can also comprise a step of downloading an advertisement to the electronic device 400. As also noted, the unique device identification can be associated with the electronic device 400 at a time the electronic device is manufactured, and afterward the stored credit can be modified. Accordingly, the method 300 can comprise a step of associating the unique device identification with the electronic device at a time of manufacture of the electronic device. The method 300 can further comprise a step of determining the amount of credit to associate with the unique device identification after the unique device identification has been associated with the electronic device 400. Yet another optional step of the method 300 is assigning the amount of stored credit to the unique device identification according to a criterion.

Still further optional steps of method 300 (FIG. 3) are described with respect to FIGS. 5 and 6. For example, the network location 410 can be further configured to store in the database 420 an alias in association with the unique device identification. Therefore, the business method 300 of the invention can further comprise storing in the database 420 an alias in association with the unique device identification. FIG. 5 illustrates exemplary steps that the network location 410 can perform in order to store an alias in the database 420. In FIG. 5, and with continued reference to FIG. 4, the method begins in a Step 510 by providing an interface for editing an alias. In some embodiments, the alias editing interface is provided to the electronic device 400 by the network location 410, while in other embodiments the alias editing interface is provided by software installed on the electronic device 400. The alias editing interface can be displayed by a GUI, for example. Next, in a Step 520 the network location 410 receives an alias selection from the electronic device 400. In a Step 530 the network location 410 determines whether the selected alias is unique by querying the database 420. If the same alias is already in use, then in a Step 540 the network location 410 provides an error message to be displayed by the electronic device 400, the error message requesting another selection, and returns to Step 520 to receive another alias selection. If the alias is unique, then in a Step 550 the network location 410 stores the alias in association with the unique device identification in the database 420. It will be appreciated that in some instances the network location 410 can propose acceptable unique aliases, and in these situations Steps 530 and 540 become unnecessary.

Another example of a transaction involves purchasing extra credits. FIG. 6 illustrates exemplary steps that the network location 410 (FIG. 4) can perform in order to support the purchase of extra credit. In a Step 610 an interface for purchasing extra credit is provided. Again, in different embodiments the interface for purchasing extra credit may be provided to the electronic device 400 by the network location 410, or by software installed on the electronic device 400. The interface for purchasing extra credit can be displayed by a GUI, for example. Through the interface the user of the electronic device 400 can specify an amount of extra credit to be purchased, and can specify a payment method, such as a credit card account. Thus, in a Step 620 the network location 410 receives the payment for the extra credit. Then, in a Step 630, the network location 410 adds the extra credit to the balance of the stored credit in the database 420 (FIG. 4).

In addition to purchasing extra credit, other transactions involving credits comprise gifting, selling, swapping, exchanging, donating, collecting, and pooling credits. By analogy to FIG. 6, a user can buy credit as a gift to another user by following steps similar to Steps 610-630. An interface is first provided through which the user can specify an amount of credit to be purchased and a recipient of the gift, for example, by specifying an alias (see FIG. 5). Payment for the amount of the credit is received by the network location 410, and then the recipient's balance is increased by the gifted amount. In some instances, payment for the gifted credit comes from other stored credit so that effectively the stored credit has been transferred. In light of the above, it will be apparent that the method 300 (FIG. 3) can optionally include any of the steps of 1) adding purchased credit to the amount of stored credit associated with the unique device identification, 2) adding purchased credit to an amount of stored credit associated with another unique device identification, and 3) transferring some or all of the credit from the amount of stored credit associated with the unique device identification to the amount of stored credit associated with the other unique device identification. It should be noted that the amount of stored credit associated with the other unique device identification may be zero prior to the transfer.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art. The term “bundled credit,” as used herein, should not be read to mean that the credit is stored within the electronic device to which it is bundled.

What is claimed is:

1. A business method comprising:
maintaining a database that associates a unique identification for an electronic device with an amount of credit stored in the database for the electronic device;
distributing the electronic device including the unique device identification, the electronic device configured to, upon being coupled to the Internet, establish a connection to a network location having access to the database and
send the unique device identification to the network-location; and
maintaining the network location, the network location configured to read the amount of stored credit from the database in response to receiving the unique device identification; and
communicate to the electronic device the amount of credit stored in the database.

2. The business method of claim 1 wherein the electronic device comprises a consumer appliance.

3. The business method of claim 1 wherein the electronic device stores the unique device identification as an encrypted file.

4. The business method of claim 1 wherein the unique device identification is derived from a serial number of the electronic device or from a random ID generator.

5. The business method of claim 1 wherein the electronic device comprises a number of sub-components and the unique device identification is derived from a combination of the serial numbers of at least some of the sub-components.

6. The business method of claim 1 wherein the electronic device includes a GUI.

7. The method of claim 1 wherein the electronic device includes a display.

8. The method of claim 1 wherein the electronic device includes a biometric device.

9. The business method of claim 1 wherein the electronic device is further configured to connect to the Internet through another electronic device.

10. The business method of claim 9 wherein the other electronic device comprises a kiosk.

11. The business method of claim 1 wherein the electronic device is further configured to, upon being coupled to the Internet, automatically establish the connection to the network location and automatically send the unique device identification to the network location.

12. The business method of claim 1 wherein the electronic device is further configured to establish the connection to the network location in response to a trigger.

13. The business method of claim 1 wherein distributing the electronic device comprises selling the electronic device.

14. The business method of claim 1 wherein maintaining the database includes maintaining a plurality of user accounts in association with the unique device identification.

15. The business method of claim 1 wherein maintaining the database includes maintaining a plurality of stored credits in association with the unique device identification.

16. The business method of claim 1 further comprising associating the unique device identification with the electronic device at a time of manufacture of the electronic device.

17. The business method of claim 16 further comprising determining the amount of credit to associate with the unique device identification after the unique device identification has been associated with the electronic device.

18. The business method of claim 1 further comprising assigning the amount of stored credit to the unique device identification according to a criterion.

19. The business method of claim 1 further comprising downloading an advertisement to the electronic device.

20. The business method of claim 1 further comprising the network location recording a transaction associated with the unique device identification and assigning a transaction ID to the transaction.

21. The business method of claim 1 further comprising storing in the database an alias in association with the unique device identification.

22. The business method of claim 1 further comprising employing a portion of the amount of stored credit in a transaction.

23. The business method of claim 22 wherein employing the portion of the amount of stored credit in the transaction includes transferring the portion of the amount of stored credit to another unique device identification.

24. The business method of claim 1 further comprising adding additional credit to the amount of credit stored in the database.

25. The business method of claim 1 further comprising transferring some or all of the amount of credit stored in the database in association with the unique device identification for the electronic device to an amount of credit stored in the database in association with another unique device identification for another electronic device.
